(19) United States
(12) Patent Application Publication
(10) Pub. No.: US 2008/0081883 A1
(43) Pub. Date: Apr. 3, 2008

(54) Polyester Polyols Derived From 2,5-Furandicarboxylic Acid, and Method

(75) Inventors: Jerry L. King II, Crawfordsville, IN (US); Alex W. Kawczak, Dublin, OH (US); Herman P. Benecke, Columbus, OH (US); Katherine P. Mitchell, Pickerington, OH (US); Michael C. Clingerman, Hilliard, OH (US)

Correspondence Address: BATTELLE MEMORIAL INSTITUTE, 505 KING AVENUE, COLUMBUS, OH, 43201-2693, US

(73) Assignee: Battelle Memorial Institute, Columbus, OH (US)

(21) Appl. No.: 11/864,043

(22) Filed: Sep. 28, 2007

Related U.S. Application Data
(60) Provisional application No. 60/847,949, filed on Sep. 28, 2006.

(51) Int. Cl. C08G 59/00

(52) U.S. Cl. 525/451

(57) ABSTRACT

Polyester polyols are provided by reaction of FDCA with polyepoxides. The polyester polyols can be used as is or further reacted to produce thermoset polymers useful for coatings particularly for those providing corrosion resistance and flame resistance.

This application claims the benefits of U.S. Provisional Application 60/847,949, filed Sep. 28, 2006. The entire disclosure of the provisional application is incorporated by reference herein.

### FIELD OF THE INVENTION

The invention provides for new polyester polyols from 2,5-furandicarboxylic acid (FDCA) and polyepoxy. Polyester polyols produced according to the invention are useful for adhesives, coatings, inks, composites, foundry binders, and/or foams. Epoxy functional terminated polyester polyols, including water dispersible epoxiterminated polyester polyols, are useful for adhesives, coatings, inks, composites, foundry binders, and/or foams. Carboxyl or carboxylate salt functional terminated polyester polyols are useful for adhesives, coatings, inks, composites, foundry binders, and/or foams. Coatings may be made directly from FDCA or FDCA salts and polyepoxide, particularly where the ratio of epoxide functionality to carboxylic acid functionality is greater than 1:1 preferably greater than 2:1. Some embodiments are expected to be useful for providing materials with corrosion resistance and/or flame resistance.

### BRIEF DESCRIPTION OF THE INVENTION

A first broad embodiment of the invention includes a method for producing a polyester polyol by providing FDCA or an FDCA-salt, and if FDCA is provided, mixing a solvent with the FDCA;

b. mixing a polyepoxide with the FDCA solvent mixture or with the FDCA-salt; and

c. heating to react the mixture, optionally in the presence of a catalyst, to form the polyester polyol. Typically the polyester polyol is further reacted with heating, with or without additional crosslinker to form a thermoset polymer. The additional crosslinker is typically selected from the group consisting of a polyfunctional epoxy, a polyfunctional isocyanate, a polyfunctional amine, and mixtures thereof. One useful polyfunctional amine comprises a carboxylic acid functionality. Typically, the polyester polyol product is heated to a temperature above that needed to make the polyester polyol wherein crosslinking occurs to form a thermoset polymer. In some embodiments from zero (0) to about 5 mole % of the total polyepoxide may be a triepoxide and the balance a diepoxide.

One embodiment has a molar ratio of carboxylic acid functionality:epoxy functionality is about 1:1. Another embodiment has a molar ratio of carboxylic acid functionality:epoxy functionality such that epoxide functionality is in excess. Another embodiment provides for a molar ratio of carboxylate functionality:epoxy functionality between 1:1 and about 1:3; and heating and reacting to form the polyester polyol at a temperature at which substantial crosslinking does not occur. Another embodiment provides for a molar ratio of the carboxylic acid functionality:epoxy functionality such that carboxyl or carboxylate salt functionality is in excess. In some embodiments the molar ratio of the carboxyl functionality and epoxy functionality is between 1.1 and about 3:1.

A yet further embodiment of the invention includes a method for making an epoxy functional polyester polyol by mixing FDCA and/or an FDCA-salt with a polyepoxide, optionally adding a solvent and/or a catalyst; wherein polyepoxide functionality is in excess; and heating and reacting to form the epoxy functional polyester polyol. In some embodiments zero to about 5 mol %, based on the total moles of epoxy, of trifunctional epoxy or higher functional epoxy is added prior to the heating and reacting step. Additional embodiments provide for heating the polyester polyol to a temperature higher than that needed to form the polyester polyol, wherein crosslinking occurs to form a thermoset polymer.

An additional embodiment includes a method for producing a thermoset polymer by mixing FDCA, a tertiary amine, and a first solvent to form a salt, optionally separating the first solvent from the mixture; mixing the product of a or b with a polyfunctional epoxy polyester polyol, and an optional catalyst, and optionally adding a second solvent if the first solvent was removed in step b; and heating and reacting to form a thermoset polymer.

Typically prior to the heating step to form a thermoset polymer, the mixture is applied to a surface and then heated to form a coating.

Another broad embodiment of the invention provides for a curable polyester polyol composition of an FDCA or an FDCA-salt; and a polyepoxide, wherein the molar ratio of carboxylic acid moieties of the FDCA or FDCA-salt:epoxy moieties of the polyepoxide ranges from about 3:1 to about 1:3. In some embodiments the molar ratio of carboxylic acid moieties of the FDCA or FDCA-salt:epoxy moieties of the polyepoxide ranges from about 1:1 to about 1:3, in others from about 3:1 to about 1:1 and in yet other it is about 1:1.

A yet further embodiment includes a method for producing a polyester polyol that provides enhanced crosslinking in the cured polyester polyol by providing FDCA or an FDCA-salt, and if FDCA-salt is provided, mixing a solvent with the FDCA; mixing a polyepoxide with the FDCA solvent mixture or with the FDCA-salt, wherein the ratio of carboxylic acid moieties from the FDCA or its salt and epoxy moieties from the polyepoxide is between 1:1 and 1:1.3 so that epoxy moieties predominate; and heating the mixture, optionally in the presence of a catalyst.

Typically FDCA or its salt and a polyepoxide is applied directly to a surface and reacted to form a coating, or is pulverized to obtain a powder that can be applied to a surface where it is further reacted by heating with or without additional catalyst to form a coating.

### DETAILED DESCRIPTION OF THE INVENTION AND BEST MODE

Broadly, the present invention includes several compositions and methods for the synthesis of polyester polyols useful for various applications including coatings. The invention includes polyester polyols that are partially cured and those that are cured to provide products having excellent properties with simple molecules and few process steps.

A first aspect of the invention includes compositions and methods for the preparation of polyester polyols typically derived from 2,5-furandicarboxylic acid (or its salt) and a polyepoxide such as a diepoxide, or a mixture of diepoxide/triepoxide. See typical Reaction 1 below.

A second aspect of the invention includes compositions and methods for the preparation of epoxide functional polyester polyols typically derived from 2,5-furandicarboxylic acid (or its salt) and a polyepoxide such as a diepoxide, or a mixture of a diepoxide/triepoxide. See typical Reaction 2 below.

A third aspect of the invention includes compositions and methods for the preparation of carboxylate salt functional polyester polyols typically derived from 2,5-furandicarboxylic acid (or its salt) and a polyepoxide such as a diepoxide, and a mixture of a diepoxide/triepoxide. See typical Reaction 3 below.

A fourth aspect of the invention includes compositions and methods for the preparation of a 2,5-furandicarboxylic acid salt typically derived from FDCA and triethylamine (TEA). See typical Reaction 4 below. Where a salt is used the FDCA-salt typically comprises a tertiary amine salt. The FDCA-tertiary amine salt is typically selected from the group including, but not limited to, an FDCA-monosalt, an FDCA-TEA disalt, or mixtures thereof. The amine salt may be an alkyl amine, a dialkyl amine, or trialkyl amine salt. In some embodiments the salt is a metal ion salt wherein the metal ion is typically selected form the group consisting of Ca, Cs, Cu, Fe, K, Li, Na, and Zn.

A fifth type of composition and method includes methods for making coatings from the polyester polyols disclosed herein. The polyester polyols typically produce solid materials or coatings and the like. The coatings may be thermoplastic or thermoset according to the ingredients and the processing conditions selected.

Broadly, it is noted that the ratio of the carboxylic acid functionality:epoxy functionality determines the end groups on the resultant polymer.

Additionally, it is noted that in some of the embodiments herein, where an optional solvent may be used, reaction in the presence of optional solvent can result in higher molecular weight product compared to not using the solvent. Where a triepoxide is used, the triepoxide has a third epoxy group attached to the R′ group in a manner similar to an epoxide of the diepoxide.

Typical solvents include, without limitation, an anhydrous solvent such as an alcohol having up to about eight carbon atoms (e.g. methanol, ethanol, isopropanol, and tert-butanol) 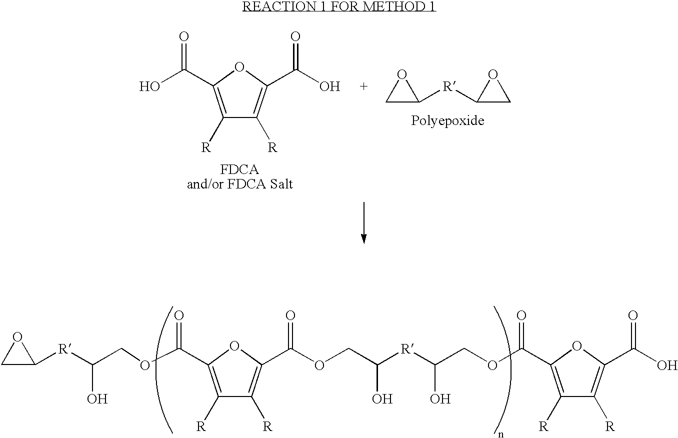
Method 1 (Illustrated in Examples 1-3, 5, 6, 10 and 12 Below)

Immediately above is a reaction illustrating the preparation of polyester polyols derived from 2,5-furandicarboxylic acid (or its salt) and a polyepoxide where the carboxylic acid functionality:epoxy functionality molar ratio is about 1:1. The polyepoxide is typically a diepoxide. In some embodiments reaction of the FDCA or FDCA salt may be at the secondary or tertiary carbon of the epoxy group. The figure shows a product with a prevalent type of end capping, it is epoxy terminated at one end and carboxy terminated at the other end of the molecule.

R may be the same or different and includes alkyl, aryl, cycloalkyl, and alkylaryl moieties. The R groups may have up to 10 carbon atoms each. The repeat unit n may range from 1 up to that where a useful polyester polyol for the application is no longer obtained. Typically the upper limit of the range for n is about 50 with up to 20 being preferred, and up to 10 most preferred.

Examples of suitable polyepoxides for producing the polyfunctional epoxide polyester polyols disclosed herein include diglycidyl ethers of polyols and polymer polyester polyols derived from epichlorohydrin and polyols (ex. bisphenol A). Examples of suitable R′ groups, other than those from the glycidyl ethers and polymers derived from them, include alkyl, alkene, aryl, cycloalkyl, and mixtures thereof. The R′ groups may have up to 10 carbon atoms.

Temperature of the reaction can vary between about 40° C. and about 90° C. with preferred temperatures between about 50° C. and about 70° C. 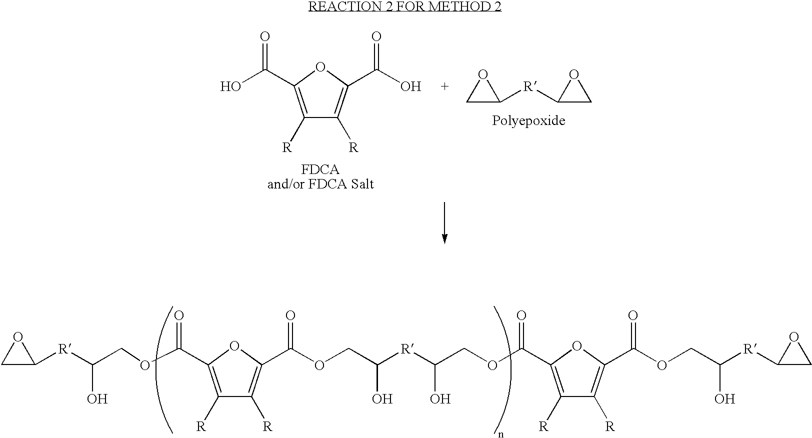
Method 2. (Illustrated in Example 9 Below)

Immediately above is a reaction illustrating the preparation of an epoxy functional polyester polyol derived from 2,5-furandicarboxylic acid (or its salt) and a polyepoxide. The polyepoxide is typically a diepoxide. In other typical embodiments up to 5 mole % based on total epoxide may be a triepoxide. The carboxylic acid functionality:epoxy functionality molar ratio typically has polyepoxide in excess up to a ratio of about 1:3. In typical embodiments up to 5 mole % based on total epoxide may be a triepoxide. In some embodiments, reaction of the FDCA or FDCA salt may be at the secondary or tertiary carbon of the epoxy group. The figure shows a product with the most prevalent type of endcapping, it is epoxy terminated at both ends of the molecule. It is expected that ether linkages are formed here also.

R may be the same or different and includes alkyl, aryl, cycloalkyl, and alkylaryl moieties. The R groups may have up to 10 carbon atoms each. The repeat unit n may range from 1 up to that where a useful polyester polyol for the application is no longer obtained. Typically the upper limit of the range for n is about 50 with up to 20 being preferred, and up to 10 most preferred.

Examples of suitable polyepoxides for producing the polyfunctional epoxide polyester polyols disclosed herein include diglycidyl ethers of polyols and polymer polyester polyols derived from epichlorohydrin and polyols (ex. bisphenol A). Examples of suitable R′ groups, other than those from the glycidyl ethers and polymers derived from them, include alkyl, alkene, aryl, cycloalkyl, and mixtures thereof. The R′ groups may have up to 10 carbon atoms.

Temperature of the reaction can vary between about 40° C. and about 90° C. with preferred temperatures between about 50° C. and about 70° C. 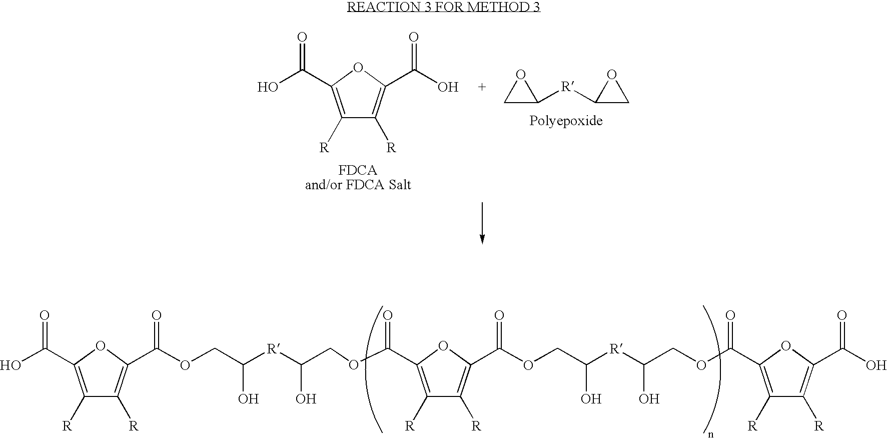
Method 3. (Illustrated in Examples 4, 7, and 8 Below; Note that Examples 4 and 7 are without the Use of a Salt While Example 8 Uses a Salt)

Immediately above is a reaction illustrating the preparation of carboxyl and/or carboxylate salt functional polyester polyols derived from 2,5-furandicarboxylic acid (or its salt) and polyepoxide. The carboxylic acid functionality:epoxy functionality molar ratio typically has carboxylic acid functional moiety in excess up to a mole ratio of about 3:1, and in another embodiment typically up to about 2:1. The polyepoxide is typically a diepoxide. In typical embodiments up to 5 mole % based on total epoxide may be a triepoxide. In typical embodiments reaction of the FDCA or FDCA salt may be at the secondary or tertiary carbon of the epoxy group. The figure shows a product with the most prevalent type of endcapping, it is carboxy terminated at both ends of the molecule.

R may be the same or different and includes alkyl, aryl, cycloalkyl, and alkylaryl moieties. The R groups may have up to 10 carbon atoms each. The repeat unit n may range from 1 up to that where a useful polyester polyol for the application is no longer obtained. Typically the upper limit of the range for n is about 50 with up to 20 being preferred, and up to 10 most preferred.

Examples of suitable polyepoxides for producing the polyfunctional epoxide polyester polyols disclosed herein include diglycidyl ethers of polyols and polymers derived from epichlorohydrin and polyols (ex. bisphenol A). Examples of suitable R′ groups, other than those from the glycidyl ethers and polymers derived from them, include alkyl, alkene, aryl, cycloalkyl, and mixtures thereof. The R′ groups may have up to 10 carbon atoms.

Temperature of the reaction can vary between about 40° C. and about 90° C. with preferred temperatures between about 50° C. and about 70° C. 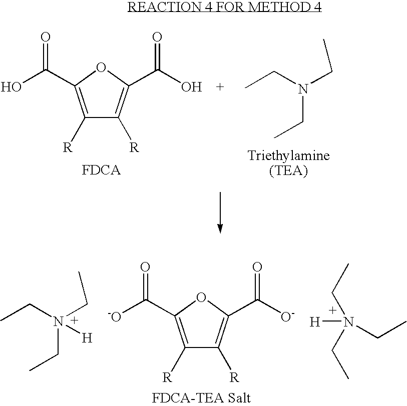
Method 4. (Illustrated in Example 8, 11, and 12 Below)

The reaction above illustrates a method for making a TEA salt of FDCA that can be used for further reaction according to the invention for producing the polyester polyols herein. 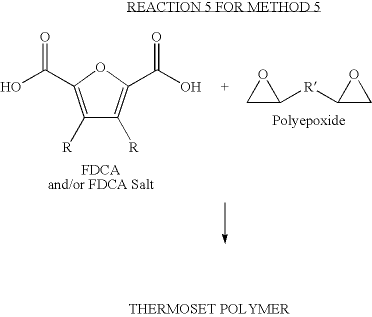
Method 5. (Illustrated in Example 11 Below)

Another aspect of the invention includes a method for making a thermoplastic or thermoset polymer and a coating from the polyester polyols herein. Typically the polyester polyols are processed in bulk or applied as a coating to a surface and then crosslinked with heat, or with heat and an additional crosslinker as further described herein.

Temperatures for curing the coating of about 110° C. to about 170° C. are appropriate.

For example, the following steps outline one typical method for obtaining a thermoset coating:

A method for forming a coating by the steps of:

mixing an FDCA-TEA di-salt with a solvent, a polyepoxide, with or without a catalyst to produce a coating formulation;

applying the coating formulation to a surface;

optionally removing the solvent before heating to dry the applied coating; and heating the dried or nondried applied coating formulation to obtain a cured coating.

The following examples are provided to illustrate several aspects of the invention and are not intended to limit the scope of the invention in any way.

### EXAMPLE 1

This example illustrates the synthesis of a polyester polyol from FDCA and a di-epoxide (PBEG) in dimethylsulfoxide (DMSO) solvent where the carboxylic acid functionality:epoxy functionality molar ratio was about 1:1 using a tertiary amine (DMAP) catalyst.

2,5-Furan dicarboxylic acid (FDCA) (5.00 g, 32.0 mmol) and dimethylsulfoxide (DMSO) (38 mL) were charged to a 250 mL round bottom flask with a continuous argon flow into the reactor. The mixture was stirred until a homogeneous solution was obtained. Poly(bisphenol A-co-epichlorohydrin), glycidyl end-capped (15.60 g, 32.0 mmol) (PBEG) was added to the mixture with a continuous argon flow into the reactor. The reactor was blanketed with argon. 4-(Dimethylamino)-pyridine (DMAP) (24.4 mg, 0.200 mmol) was added to the mixture. The reaction mixture was heated to 60° C. with stirring under argon. The mixture was stirred for 16.6 hours at 60° C. During this reaction period, the mixture became a viscous light brown liquid. A portion of the solution (5 mL) was removed for analysis. Distilled water (150 mL) was added to the remaining solution with stirring to yield a light tan precipitate. The mixture was filtered. The water wash and filtration step were repeated two more times. The precipitate was dissolved in acetone and the solution was cast into a glass dish. The crude product was dried under full vacuum at 40° C. for 15 hours to yield a sticky translucent amber solid. GPC results revealed that the polyester polyol product had a peak average molecular weight (Mp) of 1,549 g/mol.

### EXAMPLE 2

This example illustrates the synthesis of a polyester polyol from FDCA and a dipoxide (PBEG) in DMSO solvent at a carboxylic acid functionality:epoxy functionality molar ratio of about 1:1 with a tertiary amine (DMAP) catalyst.

FDCA (4.00 g, 25.6 mmol), PBEG (12.48 g, 25.6 mmol), and DMSO (94.8 mL) were charged to a 250 mL round bottom flask with a continuous argon flow into the reactor. The reactor was blanketed with argon. DMAP (0.313 g, 2.56 mmol) was added to the mixture. The reaction mixture was heated to 60° C. with stirring under argon. The mixture was stirred for 20 hours at 60° C. The mixture was then poured into distilled water (475 mL) with stirring to yield a white precipitate. The mixture was filtered. The precipitate was washed with three aliquots of distilled water (240 mL). The precipitate was dissolved in acetone and poured into a glass dish. The polymer solution was dried in a vacuum oven under full vacuum at 40° C. for 15 hours to obtain polyester polyol product (15.26 g, 93%) as a light yellow tacky solid. GPC results revealed that the polyester polyol product had a peak average molecular weight (Mp) of 1,390 g/mol.

### EXAMPLE 3

This example illustrates the synthesis of a polyester polyol from FDCA and a di-epoxide (PBEG) in DMF solvent at a carboxylic acid functionality:epoxy functionality mole ratio of about 1:1 with a tertiary amine (DMAP) catalyst.

FDCA (4.00 g, 25.6 mmol), PBEG (12.48 g, 25.6 mmol), and dimethylformamide (DMF) (30.4 mL) were charged to a 250 mL round bottom flask with a continuous argon flow into the reactor. The reactor was blanketed with argon. DMAP (18.5 mg, 0.151 mmol) was added to the mixture. The reaction mixture was heated to 60° C. with stirring under argon. The mixture was stirred for 20 hours at 60° C. The mixture was then poured into distilled water (750 mL) with stirring to yield a cream colored precipitate. The mixture was filtered. The precipitate was washed with three aliquots of distilled water (240 mL). The precipitate was dried in a vacuum oven under full vacuum at 60° C. for 15 hours to obtain polyester polyol (14.91 g, 90%) as a white solid. GPC results revealed that the polyester polyol had a peak average molecular weight (Mp) of 2,352 g/mol.

Two samples of the polymer, were vacuum dried separately for 15 hrs at 80° C. (polymer A) and 100° C. (polymer B). The color of polymer A was a white solid and polymer B was a light brownish/yellow solid. GPC analysis showed that polymer A had an Mp of 1,828 g/mol.

Polymer B was a cross-linked polymer because it was not soluble in THF or DMF. Thus, this polyester polyol could be used as a one component heat activated thermoset for various applications.

### EXAMPLE 4

This example illustrates the synthesis of a polyester polyol (carboxyl functional) from FDCA and a diepoxide (Epodil® 757) in DMF solvent at a carboxylic acid functionality:epoxy functionality mole ratio of about 1:0.797 with a tertiary amine (DMAP) catalyst.

FDCA (4.00 g, 25.6 mmol), Epodil® 757 (glycidyl ether of cyclohexane dimethanol) (6.58 g, 20.4 mmol), and DMF (70.4 mL) were charged to a 250 mL round bottom flask with a continuous argon flow into the reactor. The reactor was blanketed with argon. DMAP (0.313 g, 2.56 mmol) was added to the mixture. The reaction mixture was heated to 60° C. with stirring under argon. The mixture was stirred for 20 hours at 60° C. The mixture was then poured into distilled water (1 L) with stirring to yield a yellow precipitate. The mixture was filtered. The precipitate was washed with three aliquots of distilled water (76 mL). The polymer product was dried in a vacuum oven under full vacuum at 80° C. for 15 hours to obtain polyester polyol (4.81 g, 45%) as yellow solid. Based on IR evidence of this type of polyester polyol, the water soluble fraction was believed to contain some polyester polyol. GPC analysis of the precipitated polymer revealed that the polyester polyol had a peak average molecular weight (Mp) of 2,446 g/mol.

### EXAMPLE 5

This example illustrates the synthesis of a polyester polyol from FDCA and a di-epoxide (carboxylic acid functionality:epoxy functionality molar ratio 1:1) catalyzed by 1-methylimidazole.

FDCA (4.00 g, 25.6 mmol), PBEG (12.48 g, 25.6 mmol); and DMSO (94.8 mL) were charged to a 250 mL round bottom flask with a continuous argon flow into the reactor. The reactor was blanketed with argon. 1-Methylimidazole (12 μl, 0.151 mmol) was added to the mixture using an argon filled syringe. The reaction mixture was heated to 60° C. with stirring under argon. The mixture was stirred for 20 hours at 60° C. The mixture was then poured into distilled water (475 mL) with stirring to yield a yellow precipitate. The mixture was filtered. The precipitate was washed with three aliquots of distilled water (240 mL). The precipitate was dissolved in acetone and poured into a glass dish. The polymer solution was dried in a vacuum oven under full vacuum at 40° C. for 15 hours to obtain polyester polyol (18.56 g, >100%) as a light yellow tacky solid. GPC results revealed that the polyester polyol had a peak average molecular weight (Mp) of 1,324 g/mol.

### EXAMPLE 6

This example illustrates the synthesis of a polyester polyol from FDCA and a polyepoxide (carboxylic acid functionality:epoxy functionality mole ratio 1:1) catalyzed by pyridine.

FDCA (4.00 g, 25.6 mmol), PBEG (12.48 g, 25.6 mmol), and DMSO (94.8 mL) were charged to a 250 mL round bottom flask with a continuous argon flow into the reactor. The reactor was blanketed with argon. Pyridine (12 μl, 0.148 mmol) was added to the mixture using an argon filled syringe. The reaction mixture was heated to 60° C. with stirring under argon. The mixture was stirred for 20 hours at 60° C. FT-IR analysis of the product indicated the reaction was not complete. The reaction mixture was then heated to 80° C. with stirring under argon. The mixture was stirred for 22 hours at 80° C. The mixture was then poured into distilled water (475 mL) with stirring to yield a yellow precipitate. The mixture was filtered. The precipitate was washed with three aliquots of distilled water (240 mL). The precipitate was dissolved in acetone and poured into a glass dish. The polymer solution was dried in a vacuum oven under full vacuum at 40° C. for 15 hours to obtain polyester polyol (21.18 g, >100%) as a dark orange tacky solid. GPC results revealed that the polyester polyol had a peak average molecular weight (Mp) of 1,494 g/mol.

### EXAMPLE 7

This example illustrates the synthesis of a polyester polyol (carboxyl functional) from FDCA and a bis-epoxide (carboxylic acid functionality:epoxy functionality mole ratio 1:0.797) catalyzed by 1,1′-carbonyldiimidazole.

FDCA (4.00 g, 25.6 mmol), Epodil® 757 (6.57 g, 20.4 mmol), and DMF (70.4 mL) were charged to a 250 mL round bottom flask with a continuous argon flow into the reactor. The reactor was blanketed with argon. 1,1′-Carbonyldiimidazole (CDI) (24.5 mg, 0.151 mmol) was added to the mixture. The reaction mixture was heated to 60° C. with stirring under argon. The mixture was stirred for 20 hours at 60° C. The mixture was then poured into distilled water (750 mL) with stirring to yield a yellow precipitate. The mixture was filtered. The precipitate was washed with three aliquots of distilled water (76 mL). The cloudy filtrate was centrifuged for 30 minutes to give a tacky residue at the bottom of the tube. The water was decanted off and the residue was dissolved in acetone and combined with the precipitate. The solution was cast into a glass dish. The polymer solution was dried in a vacuum oven under full vacuum at 80° C. for 15 hours to obtain polyester polyol (3.65 g, 35%) as a golden solid. Based on IR evidence of this type of polyester polyol, the water soluble fraction was believed to contain some polyester polyol. GPC analysis of the precipitated polymer revealed that the polyester polyol had a peak average molecular weight (Mp) of 1,530 g/mol.

### EXAMPLE 8

This example illustrates the synthesis of a polyester polyol (carboxylate salt functional) from 2,5-FDCA-TEA di-salt and a bis-epoxide (carboxylic acid functionality:epoxy functionality mole ratio 1:0.797).

FDCA (2.00 g, 12.8 mmol) and triethylamine (TEA, 99.5%) (2.59 g, 25.6 mmol) were charged to a 250 mL round bottom flask with a continuous argon flow into the reactor. The reactor was blanketed with argon. Anhydrous methanol (15.2 mL) was added to the mixture using an argon filled syringe. The mixture was stirred at room temperature until a homogeneous solution formed. The homogeneous solution was stirred under argon for 30 minutes. The methanol was removed by a rotating evaporator to obtain the FDCA-TEA di-salt as a light yellow solid. The polyester polyol was prepared by charging Epodil 757 (3.28 g, 10.2 mmol) to the FDCA-TEA di-salt with a continued argon purge into the reactor. The reactor was blanketed with argon. The reaction mixture was heated to 70° C. with stirring under argon. The viscosity of the mixture increased during the reaction. The mixture was maintained at 70° C. for 18 hours, but the stirring had stopped sometime before the 18 hour reaction period. FT-IR analysis of this sample showed that ester had formed.

### EXAMPLE 9

This example illustrates the synthesis of an epoxy functional polyester polyol from 2,5-FDCA-TEA di-salt and a diepoxide (carboxylic acid functionality:epoxy functionality mole ratio of about 1:2).

FDCA (2.00 g, 12.8 mmol) and TEA (99.5%) (2.59 g, 25.6 mmol) were charged to a 250 mL round bottom flask with a continuous argon flow into the reactor. The reactor was blanketed with argon. Anhydrous methanol (15.2 mL) was added to the mixture using an argon filled syringe. The mixture was stirred at room temperature until a homogeneous solution formed. The homogeneous solution was stirred under argon for 30 minutes. The methanol was removed by a rotating evaporator to obtain the FDCA-TEA di-salt as a light yellow solid. The polyester polyol was prepared by charging Epodil 749 (glycidyl ether of neopentyl glycol) (7.07 g, 25.6 mmol) to the FDCA-TEA di-salt with a continued argon purge into the reactor. The reactor was blanketed with argon. The reaction mixture was heated to 60° C. with stirring under argon. The viscosity of the mixture increased during the reaction. The mixture was maintained at 60° C. for 20 hours, but the stirring had stopped sometime before the 20 hour reaction period. FT-IR analysis of this sample showed that ester had formed.

The above example produced an epoxy functional polyester polyol that was made with a salt. The reaction should be brought to substantial completion, for example at the conditions shown it may take up to 44 hours to get a high molecular weight.

### EXAMPLE 10

This example illustrates synthesis of a polyester polyol from 2,5-FDCA-TEA di-salt and a diepoxide (carboxylic acid functionality:epoxy functionality mole ratio 1:1) without a catalyst.

FDCA (2.00 g, 12.8 mmol) and TEA (99.5%) (2.59 g, 25.6 mmol) were charged to a 250 mL round bottom flask with a continuous argon flow into the reactor. The reactor was blanketed with argon. Anhydrous methanol (15.2 mL) was added to the mixture using an argon filled syringe. The mixture was stirred at room temperature until a homogeneous solution formed. The homogeneous solution was stirred under argon for 30 minutes. The methanol was removed by a rotating evaporator to obtain the FDCA-TEA di-salt as a light yellow solid. The polyester polyol was prepared by charging Epodil 749 (3.54 g, 12.8 mmol) to the FDCA-TEA di-salt with a continued argon purge into the reactor. The reactor was blanketed with argon. Anhydrous tert-butanol (30 mL) was added to the mixture using an argon filled syringe. The reaction mixture was heated to 60° C. with stirring under argon. After 17 hours of stirring at 60° C. the mixture was a little cloudy. After 23 hours the mixture was cloudier. After 46 hours, two phases were observed. The total reaction period was 47 hours. The two phases were separated and each cast into individual glass dishes. The liquids were dried in a vacuum oven under full vacuum at 60° C. for 15 hours. The bottom layer became a cream colored brittle powder after drying and the top layer became a tacky yellow semi-solid upon drying. The majority of the product (95%) was the cream colored brittle solid. FT-IR analysis of it showed that some ester had formed, but a significant amount of free carboxylate salt remained. ¹H NMR analysis showed that this product had ester linkages as well as ether linkages. Ethers are formed by the reaction of the hydroxyl groups formed as a result of the esterification reaction. FT-IR and ¹H NMR analysis of the minor residue that remained in the tert-butanol showed that it also contained ester and ether linkages, but the ratio of ester over salt was higher.

### EXAMPLE 11

This example illustrates synthesis of a coating from 2,5-FDCA-TEA di-salt and an polyepoxide (Epon® 828).

The FDCA-TEA di-salt prepared in Example 8 was use in the two coating formulations shown in Table 1.

TABLE 1
Coating Formulations

| | A | 6 |
|---|---|---|
| FDCA-TEA di-salt (wt %) | 22.05 | 21.67 |
| 2-propanol - solvent(wt %) | 44.10 | 43.34 |
| Polyepoxide (wt %) | 33.86 | 33.27 |
| Zinc chelate catalyst (wt %) | 0 | 1.72 |
| Total Wt. % | 100 | 100 |
| Epoxy group/Carboxylic Acid group | 1.27 | 1.27 |
| Mole Ratio | | |

=Epon ® 828 - a difunctional epoxide
zinc chelate catalyst = NACURE ® XC-9206
Since epoxy moieties were in excess it is expected that ether linkages between epoxy moieties are formed here also.

The coatings were mixed as shown in the listing of ingredients in Table 1 and drawn down on steel Q-panels with a #22 wire bar. Based on the percent solids, the coating was approximately two (2) mils thick dry film build. The panels were flashed for about five (5) minutes to allow the solvent to evaporate then placed in a 140° C. oven for 15 minutes. The tests shown in Table 2 were conducted soon after the panels were removed from the oven.

TABLE 2
Coating Evaluations

| | | | Crosshatch | ⅛″ | MEK |
|---|---|---|---|---|---|
| | 60° C. | Pencil | adhesion | Mandrel | double |
| Coating | Gloss | Hardness | (% pass) | Bend | rubs |
| A | 87.8 | 3H | 100 | Fail | 15 |
| B | 87.7 | 3H | 100 | Pass | 25 |

The gloss is high and the pencil hardness is useful for an industrial coating. The good hardness obtained is consistent with a degree of crosslinking that is attributed to interchain ether formation.

While Coating B has a better flexibility test result. The MEK rubs are low, but this may be due to the tests being performed so soon after the heat cure. This increased over time. Additional tests gave better results for MEK rubs when the material was aged over a period of one month at room temperature. The result for coating A was about 40 and that for coating B was about 100+.

The above tests show that temperatures for making coatings of about 110° C. to about 170° C. are appropriate.

Spectral evidence indicated when a 1:1 mole ratio of carboxylic acid and epoxide functionality were reacted that some ether formation occurred in addition to ester formation. Ether formation presumably results from attack of initially formed alkoxide or alcohol functionality positioned on the growing polymer chain on epoxide functionality either on the reagent polyepoxide or terminal epoxide groups on growing polymer chains. However, this secondary reaction will lead to a deficiency of epoxide groups from the 1:1 ratio needed to form higher molecular weight polyester polyols by this approach. Adding greater than a 1:1 mole ratio of epoxide functionality to acid functionality addresses this inequality of reactive carboxylic and epoxide functionality. A probable beneficial result of ether formation is that it allows crosslinking between different growing chains that can provide strength and hardness to the derived product. Adding greater than a 1:1 mole ratio of epoxide functionality to acid functionality should also favor additional crosslinking based on enhanced concentrations of initially formed alkoxide or alcohol functionality and epoxide concentration provided by reagent polyepoxides.

The aforementioned increasing ether formation at higher ratios of epoxy moiety to carboxylic acid moiety (i.e. from above about 1:1 to about 3:1) allows the tailoring of cured resins with bulk products or coatings having enhanced physical properties. In particular it allows the production of crosslinked products without the addition of additional types of crosslinkers.

### EXAMPLE 12

This example illustrates the synthesis of polyester polyol from 2,5-FDCA Salt and a polyepoxide (PBEG) catalyzed by DMAP.

FDCA (2.00 g, 12.8 mmol) and triethylamine (TEA, 99.5%) (1.30 g, 12.8 mmol) were charged to a 250 mL round bottom flask with a continuous argon flow into the reactor. The reactor was blanketed with argon. Anhydrous DMF (15.2 mL) was added to the mixture using an argon filled syringe. The mixture was stirred at room temperature until a homogeneous solution formed. The homogeneous solution was stirred under argon for 30 minutes. The polyester polyol was prepared by charging PBEG (6.24 g, 12.8 mmol) to the FDCA-TEA di-salt with a continued argon purge into the reactor. The reactor was blanketed with argon. 4-(Dimethylamino)-pyridine (DMAP) (157 mg, 1.28 mmol) was added to the mixture. The reaction mixture was heated to 60° C. with stirring under argon. The mixture was stirred for 20 hours at 60° C. The mixture was then poured into distilled water (500 mL) with stirring to yield a tan colored precipitate. The mixture was filtered. The precipitate was washed with three aliquots of distilled water (38 mL). The polymer was dried in a vacuum oven under full vacuum at 60° C. for 15 hours to obtain polyester polyol (7.04 g, 85%) as a brown solid. GPC analysis of the precipitated polymer revealed that the polyester polyol had a peak average molecular weight (Mp) of 1,600 g/mol.

While the forms of the invention herein disclosed constitute presently preferred embodiments, many others are possible. It is not intended herein to mention all of the possible equivalent forms or ramifications of the invention. It is to be understood that the terms used herein are merely descriptive, rather than limiting, and that various changes may be made without departing from the spirit of the scope of the invention.

We claim:

1. A method for producing a polyester polyol comprising:
a. providing FDCA or an FDCA-salt, and if FDCA is provided, mixing a solvent with the FDCA;
b. mixing a polyepoxide with the FDCA solvent mixture or with the FDCA-salt; and
c. heating to react the mixture, optionally in the presence of a catalyst, to form the polyester polyol.

2. The method according to claim 1, further comprising:
d. further reacting the polyester polyol with a crosslinker to form a thermoset polymer.

3. The method according to claim 2, wherein the crosslinker is selected from the group consisting of a polyfunctional epoxy, a polyfunctional isocyanate, a polyfunctional amine, and mixtures thereof.

4. The method according to claim 3, wherein the polyfunctional amine comprises a carboxylic acid functionality.

5. The method according to claim 1, wherein the polyester polyol product is heated to a temperature above that needed to make the polyester polyol wherein crosslinking occurs to form a thermoset polymer.

6. The method according to claim 1, wherein from zero (0) to about 5 mole % of the total polyepoxide may be a triepoxide and the balance a diepoxide.

7. The method according to claim 1, wherein the molar ratio of the carboxylic acid functionality:epoxy functionality is about 1:1.

8. The method according to claim 1, wherein the molar ratio of the carboxylic acid functionality:epoxy functionality is such that epoxide functionality is in excess.

9. The method according to claim 1, wherein the molar ratio of carboxylate functionality:epoxy functionality is between 1:1 and about 1:3;
and heating and reacting to form the polyester polyol at a temperature at which substantial crosslinking does not occur.

10. The method according to claim 1, wherein the molar ratio of the carboxylic acid functionality:epoxy functionality is such that carboxyl or carboxylate salt functionality is in excess.

11. The method according to claim 1, wherein the molar ratio of the carboxyl functionality and epoxy functionality is between 1.1 and about 3:1.

12. The method according to claim 1, wherein the molar ratio of the carboxyl functionality and epoxy functionality is about 1:1.

13. A method for making an epoxy functional polyester polyol comprising:
a. mixing FDCA and/or an FDCA-salt with a polyepoxide, optionally adding a solvent and/or a catalyst; wherein polyepoxide functionality is excess; and
b. heating and reacting to form the polyester polyol.

14. The method according to claim 16, wherein zero to about 5 mol %, based on the total moles of epoxy, of trifunctional epoxy or higher functional epoxy is added prior to the heating and reacting step.

15. The method according to claim 13, wherein the polyester polyol is heated to a temperature higher than that needed to form the polyester polyol, wherein crosslinking occurs to form a thermoset polymer.

16. The method according to claim 13, wherein the ratio of the equivalent basis of carboxylic acid functionality:epoxy functionality is equal to or greater than 1:1.

17. A method for producing a thermoset polymer comprising:
a. mixing FDCA, a tertiary amine, and a first solvent to form a salt
b. optionally separating the first solvent from the mixture;
c. mixing the product of a or b with a polyfunctional epoxy, and an optional catalyst, and optionally adding a second solvent if the first solvent was removed in step b; and
d. heating and reacting to form a thermoset polymer.

18. The method according to claim 17, wherein the tertiary amine comprises TEA.

19. The method according to claim 17, wherein prior to the heating step d the mixture of step c is applied to a surface.

20. The method according to claim 19, wherein a coating is formed on the surface.

21. The method according to claim 19 wherein the polyfunctional epoxy is a di-functional epoxy.

22. A thermoset produced by the method according to claim 20

23. A curable polyester polyol composition comprising:
a. an FDCA or an FDCA-salt; and
b. a polyepoxide, wherein the molar ratio of carboxylic acid functionality of the FDCA or FDCA-salt and the epoxy functionality of the polyepoxide ranges from about 3:1 to about 1:3.

24. The curable polyester polyol composition according to claim 23, wherein the molar ratio of carboxylic acid moieties of the FDCA or FDCA-salt:epoxy moieties of the polyepoxide ranges from about 1:1 to about 1:3.

25. The curable polyester polyol composition according to claim 23, wherein the molar ratio of carboxylic acid moieties of the FDCA or FDCA-salt:epoxy moieties of the polyepoxide ranges from about 3:1 to about 1:1.
